(19) United States
(12) Patent Application Publication
(10) Pub. No.: US 2014/0160090 A1
(43) Pub. Date: Jun. 12, 2014

(54) PHOTOSENSITIVE INPUT-OUTPUT DEVICE AND PHOTOSENSITIVE INPUT-OUTPUT PANEL

(71) Applicants: Hong Fu Jin Precision Industry (ShenZhen) Co., Ltd., (US); HON HAI PRECISION INDUSTRY CO., LTD., New Taipei (TW)

(72) Inventors: KAI XU, Shenzhen (CN); HUI YIN, Shenzhen (CN); CHUN-WEI PAN, New Taipei (TW); SHUANG RUI, Shenzhen (CN)

(73) Assignees: HON HAI PRECISION INDUSTRY CO., LTD., New Taipei (TW); HONG FU JIN PRECISION INDUSTRY (ShenZhen) CO., LTD., Shenzhen (CN)

(21) Appl. No.: 13/873,127

(22) Filed: Apr. 29, 2013

(30) Foreign Application Priority Data
Dec. 7, 2012 (CN) 2012105218225

(51) Int. Cl. G06F 3/0354

(52) U.S. Cl. CPC G06F 3/03545
USPC 345/179

(57) ABSTRACT

A photosensitive input device includes a stylus, a photosensitive input panel including an induction layer, a photoelectric detecting circuit, a driving circuit, a controller, and a storage device. The induction layer includes a plurality of units including a light-emitting element and a photosensitive element. The photosensitive element outputs an induced current when struck by the stylus. The photoelectric detecting circuit determines coordinates of the photosensitive element generating the induced current and the intensity of the induced current. The driving circuit generates a driving current in response to the controller based on the induced current and the illuminated icon, and outputs the driving current to the light-emitting elements for adjusting the brightness of the light-emitting elements.

### CROSS-REFERENCE TO RELATED APPLICATIONS

Related subject matter is disclosed in co-pending U.S. patents application with an Attorney Docket Number US46962 and a title of PHOTOSENSITIVE INPUT DEVICE AND PHOTOSENSITIVE INPUT PANEL, which has the same assignees as the current application and was concurrently filed.

### BACKGROUND

1. Technical Field

The present disclosure relates to input devices and particularly to a photosensitive input-output device and a photosensitive input-output panel.

2. Description of the Related Art

LED display devices with touch screens are common, and such touch screen generally includes a touch panel positioned over a LED display screen or a plurality of touch detecting elements integrated with the LED display screen, thus increasing the thickness of the LED display device as well as generating heat, and further decreasing the brightness of the display screen in the touch screens.

Therefore, there is room for improvement within the art.

### BRIEF DESCRIPTION OF THE DRAWINGS

The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a schematic view of a photosensitive input-output device according to an exemplary embodiment.

FIG. 2 is a schematic view of an induction layer of the photosensitive input-output device of FIG. 1.

FIG. 3 is a block diagram of the photosensitive input-output device of FIG. 1.

### DETAILED DESCRIPTION

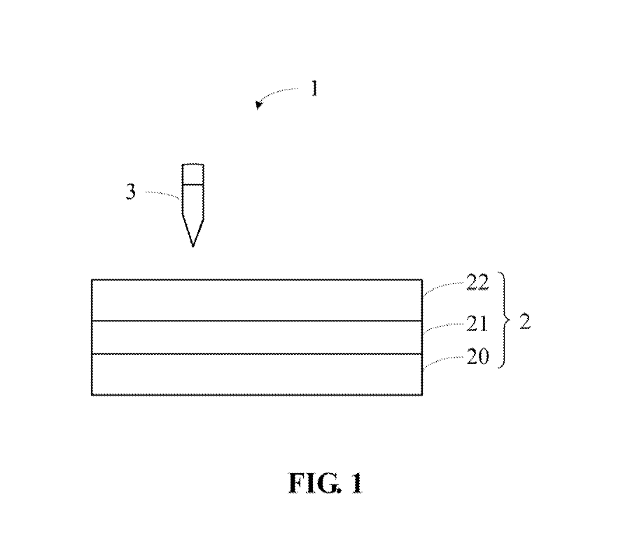

Referring to FIG. 1, a photosensitive input-output device 1 according to an exemplary embodiment includes a photosensitive input-output panel 2 and a stylus 3. The photosensitive input-output panel 2 includes a substrate 20, an induction layer 21, and a cover 22. The induction layer 21 is sandwiched between the substrate 20 and the cover 22. The stylus 3 emits light with specific wavelengths.

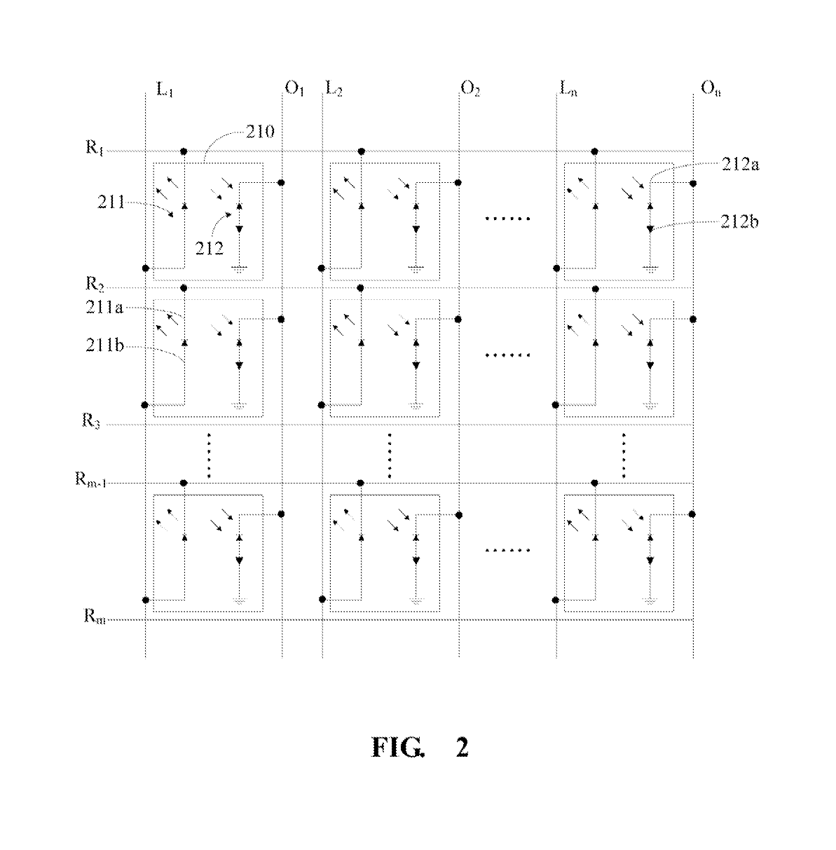

Referring to FIG. 2, the induction layer 21 includes m*n photosensitive units 210, where m, n are natural numbers. Each of the photosensitive units 210 includes a light-emitting element 211 and a photosensitive element 212 coupled with the light-emitting element 211. In the embodiment, the light-emitting element 211 is a light-emitting diode, the photosensitive element 212 is a photosensitive diode. Each light-emitting element 211 includes a first terminal 211a and a second terminal 211b, and each photosensitive element 212 includes a first terminal 212a and a second terminal 212b. The first terminals 211a of the light-emitting elements 211 in a single horizontal row are connected to a row wire Rᵢ. The second terminals 211b of the light-emitting elements 211 in a single vertical column are connected to a column wire Lⱼ. The first terminals 212a of the photosensitive elements 212 of one column are connected together to form an output terminal Oⱼ. The second terminal 212b of each photosensitive element 212 is grounded, thus i=1, 2, . . . n, j=1, 2, . . . m.

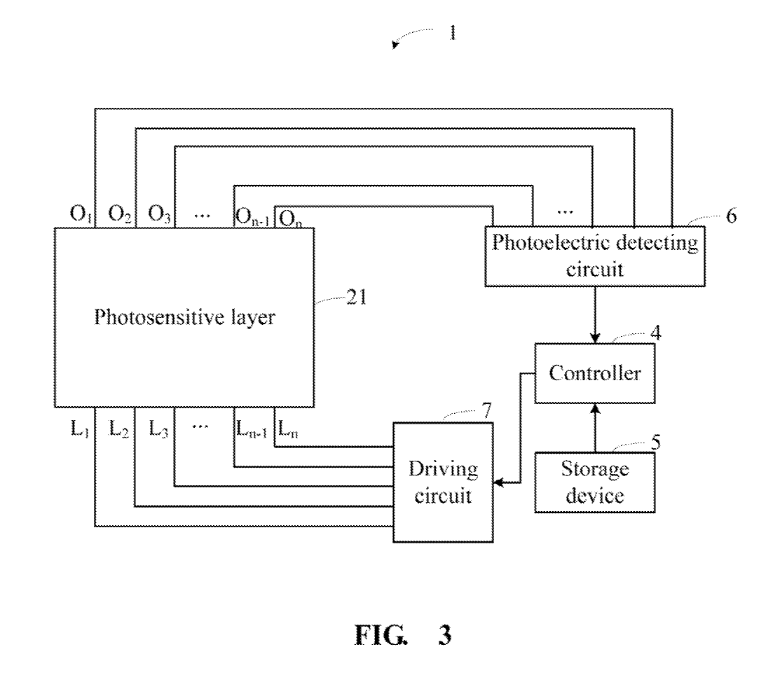

Referring to FIG. 3, the photosensitive input-output device 1 further includes a controller 4, a storage device 5, a photoelectric detecting circuit 6, and a driving circuit 7.

The storage device 5 is connected to the controller 4, and stores coordinates in the system of the panel 2. The photosensitive units 210 determine the coordinates of the system of the panel 2, that is, the light-emitting element 211 and the photosensitive element 212 of each photosensitive unit 210 represent particular coordinates of the system of the panel 2.

The controller 4 generates a first control signal in response to user's operation by means of the stylus 3 on the desktop or to execute a selected program. The driving circuit 7 is configured to generate a driving current in response to the first control signal generated by the controller 4, and outputs the driving current to the light-emitting elements 211 via the column wire Lᵢ for adjusting the brightness of the light-emitting elements 211. Thus, the brightness of the light-emitting elements 211 is adjusted in response to the first control signal to display a visible user interface of the executable program on the panel 2. The user interface may include elements such as text, images, and/or icons.

The photoelectric detecting circuit 6 is connected to the photosensitive elements 212 via the output terminal Oᵢ. The stylus 3 is operated by user to emit light, when the light of the stylus 3 strikes an icon of the user interface, the photosensitive elements 212 under the icon senses the light and generate an induced current Iᵢ. The output terminal Oᵢ outputs the induced current Iᵢ to the photoelectric detecting circuit 6. The induced current Iᵢ precisely reflects the wavelength(s) of the light emitted by the stylus 3, where the induced current Iᵢ includes the intensity value of the induced current Iᵢ.

The photoelectric detecting circuit 6 is configured to determine which one(s) of the photosensitive elements 212 generates the induced current Iᵢ, and therefore to determine the coordinates of the photosensitive element 212 that generates the induced current Iᵢ and the coordinate of the light-emitting element 211 coupled with the photosensitive element 212, and is further configured to determine the intensity of the induced current Iᵢ.

The storage device 5 further stores a pre-defined table mapping a relationship between intensities of the inducted current Iᵢ, icons and operation instructions to be executed by the device 1. The controller 4 determines the particular icon which the light of the stylus 3 illuminates according to the coordinates of the photosensitive element 212 as determined by the photoelectric detecting circuit 6. Furthermore, the controller 4 determines the operation instruction according to the pre-determined table and the intensity of the induced current Iᵢ as determined by the photoelectric detecting circuit 6. In the embodiment, the operation instructions include single clicking and double-clicking. The execution of the operation instructions accordingly activate functions in relation to the icons.

The controller 4 also generates a second control signal in response to the determined operation instruction. The driving circuit 7 generates driving current in response to the second control signal generated by the controller 4, and outputs the driving current to the light-emitting elements 211 via the corresponding column wire Lⱼ for adjusting the brightness of the light-emitting elements 211 to display a result of executing the determined operation instruction.

For example, if the stylus 3 emits light to illuminate an icon, with a first wavelength, the photosensitive elements 212 illuminated thereby generate a first induced current. The controller 4 determines the operation instruction to be “single click on the icon,” according to the pre-determined table and the intensity of the first induced current, and generates the second control signal. The driving circuit 7 increases the brightness of the light-emitting elements 211 to correspond to the first control signal, which results in the icon being highlighted. In another embodiment, the driving circuit 7 decreases the brightness of the light-emitting elements 211 to correspond to the first control signal, which results in the icon being grayed. If the stylus 3, with a second wavelength, illuminates an icon, the photosensitive elements 212 illuminated thereby generate a second induced current. The controller 4 determines the operation instruction to be “double-clicking the icon,” according to the pre-determined table and the intensity of the second induced current, and generates the second control signal. The driving circuit 7 thereby adjusts the brightness of the light-emitting elements 211 to correspond to the operation instruction determined by the controller 4, which results in displaying a user interface of an executable program corresponding to the icon.

It is understood that the present disclosure may be embodied in other forms without departing from the spirit thereof. The present examples and embodiments are to be considered in all respects as illustrative and not restrictive, and the disclosure is not to be limited to the details given herein.

What is claimed is:

1. A photosensitive input-output device, comprising:
a stylus operable to emit light;
a photosensitive input-output panel comprising:
an induction layer configured to display icons, sensing light of the stylus on the icons and outputting results triggered by the light of the stylus on the icons, the induction layer comprising:
a plurality of photosensitive units arranged in matrix, each of the plurality of icons coupled with at least one photosensitive unit, and each of the plurality of photosensitive units comprising:
a light-emitting element corresponding to a particular coordinate and comprising a first terminal and a second terminal, the first terminals in a single row connected to a row wire, the second terminals in a single column connected to a column wire; and
a photosensitive element coupled with the light-emitting element and comprising a first terminal and a second terminal, the first terminals of one column connected together to form an output terminal, each second terminal being grounded, the photosensitive element configured to generate an induced current when sensing the light from the stylus, the output terminal configured to output the induced current;
a storage device configured to store a pre-defined table recording mapping relationship between intensities of the induced current, the icons and operation instructions;
a photoelectric detecting circuit connected to the output terminals of the photosensitive elements, and configured to determine the coordinate of the photosensitive elements that generates the induced current, and further configured to determine the intensity of the induced current;
a controller configured to determine the icon and the operation instruction on the icon according to the pre-determined table and the intensity of the induced current determined by the photoelectric detecting circuit, execute the operation instruction, and further generate a corresponding control signal; and
a driving circuit connected to the column wires, and configured to generate driving current in response to the control signal generated by the controller, determine the column wire according to the coordinates of the photosensitive elements determined by the photoelectric detecting circuit, and further configured to output the driving current generated to the light-emitting elements via the determined column wire for adjusting the brightness of the light-emitting elements to display a result of executing the operation instruction.

2. The photosensitive input-output device as recited in claim 1, wherein the photosensitive input panel further comprises a substrate and a cover, and the induction layer is sandwiched between the substrate and the cover.

3. The photosensitive input-output device as recited in claim 1, wherein the induced current precisely reflects the wavelength of the lights emitted by the stylus.

4. The photosensitive input-output device as recited in claim 3, wherein the induced current comprises the intensity value of the induced current.

5. The photosensitive input-output device as recited in claim 1, wherein the driving circuit outputs a first driving current to increase the brightness of the light-emitting element coupled with an icon to display the second user interface if the stylus emits light with a first wavelength to strike the icon displayed on the first user interface; the driving circuit outputs a second driving current to adjusts the brightness of the light-emitting elements to correspond to the operation instruction executed by the controller to display the second user interface if the stylus emits light with a second wavelength reaches on the icon displayed on the first user interface.

6. A photosensitive input-output panel comprising:
a substrate; and
an induction layer disposed on the substrate, the induction layer configured to display icons, sensing light of the stylus on the icons and outputting results triggered by the light of the stylus on the icons, and each of the photosensitive units comprising a light-emitting element and a photosensitive element coupled with the light-emitting element, the photosensitive element being operable to generate an induced current when sensing light from a stylus, each photosensitive element connected to an output terminal configured to output the induced current to the controller to execute operation instruction corresponding to the icon coupled to the photosensitive element, and each light-emitting element connected to a column wire which is configured to input a driving current generated in response to the controller executing the operation instruction to adjust the brightness of the light-emitting element to display a corresponding second user interface.

7. The photosensitive input-output panel as recited in claim 6, wherein each light-emitting element comprises a first terminal and a second terminal, the first terminals in a single row connected to a row wire, the second terminals in a single column connected to a column wire; each photosensitive element corresponding to a particular coordinate and comprises a first terminal and a second terminal, the first terminals of one column connected together to form the output terminal, each second terminal is grounded.

8. The photosensitive input panel as recited in claim 6, further comprising a cover disposed on the induction layer.

9. The photosensitive input-output panel as recited in claim 6, wherein the induced current precisely reflects the wavelength of the lights emitted by the stylus.

10. The photosensitive input-output panel as recited in claim 6, wherein the column wire is configured to input a first driving current to increase the brightness of the light-emitting element coupled with an icon to display the second user interface if the stylus emits light with a first wavelength to strike the icon displayed on the first user interface; the column wire is configured to input a second driving current to adjust the brightness of the light-emitting elements to correspond to the operation instruction executed by the controller to display the second user interface if the stylus emits light with a second wavelength reaches on the icon displayed on the first user interface.

11. A photosensitive input-output panel comprising:
a substrate; and
an induction layer disposed on the substrate, the induction layer configured to display icons, sensing light of the stylus on the icons and outputting results triggered by the light of the stylus on the icons, the induction layer comprising:
a plurality of photosensitive units arranged in matrix, each of the plurality of icons coupled to at least one photosensitive unit, and each of the plurality of photosensitive units comprising:
a photosensitive element corresponding to a particular coordinate and comprising a first terminal and a second terminal, the first terminals of one column connected together to form an output terminal, each second terminal being grounded, the photosensitive element configured to generate an induced current when sensing the light from the stylus, the output terminal configured to output the induced current to the controller to execute operation instruction corresponding to the icon coupled to the photosensitive element; and
a light-emitting element coupled with the photosensitive element and comprising a first terminal and a second terminal, the first terminals in a single row connected to a row wire, the second terminals in a single column connected to a column wire, the column wire configured to input a driving current generated in response to the controller executing the operation instruction to adjust the brightness of the light-emitting element to display a corresponding second user interface.

12. The photosensitive input-output panel as recited in claim 11, further comprising a cover disposed on the induction layer.

13. The photosensitive input-output panel as recited in claim 11, wherein the induced current precisely reflects the wavelength of the lights emitted by the stylus.

14. The photosensitive input-output panel as recited in claim 11, wherein the column wire is configured to input a first driving current to increase the brightness of the light-emitting element coupled with an icon to display the second user interface if the stylus emits light with a first wavelength to strike the icon displayed on the first user interface; the column wire is configured to input a second driving current to adjust the brightness of the light-emitting elements to correspond to the operation instruction executed by the controller to display the second user interface if the stylus emits light with a second wavelength reaches on the icon displayed on the first user interface.
